(19) United States
(12) Patent Application Publication
(10) Pub. No.: US 2004/0112802 A1
(43) Pub. Date: Jun. 17, 2004

(54) System for separating and aligning small parts

(76) Inventor: Volker Labach, Lippstadt (DE)

Correspondence Address: BARNES & THORNBURG, 750-17TH STREET NW, SUITE 900, WASHINGTON, DC, 20006, US

(21) Appl. No.: 10/660,610

(22) Filed: Sep. 12, 2003

(30) Foreign Application Priority Data
Sep. 14, 2002 (DE) 102 42 855.7-22

(51) Int. Cl. B07C 5/02; B07B 13/07

(52) U.S. Cl. 209/540; 209/659

(57) ABSTRACT

A system for separating and aligning small parts including a separating device arranged on an output side of a storage container. The separating device is adjoined by an aligning station connected with a transfer device. The aligning station precisely positions each small part to be transferred and the transfer device transfers each small part to a processing unit.

### BACKGROUND

The present disclosure relates to a system for separating and aligning small parts.

Such systems are used for separating and aligning screws, rivets or other connection elements, which occur in bulk material, with respect to their precise position, so that they can be transferred in a defined manner to a processing unit, for example, to an automatic mounting device or the like.

These systems, which align small parts having a head, have, for example, a swingingly driven conveying pot. The conveying pot, on the interior side, has conveying troughs, by which the small parts, situated as bulk in the interior of the conveying pot, are conveyed to an upper outlet, where they are then aligned in a precise position in a sorting baffle. The small parts are then fed to a separating device which transfers the individual small parts in a defined sequence to a processing unit for further use. In this case, the small parts are conveyed, for example, by a linear conveyor from the sorting baffle, which represents an aligning station, to the separating unit.

The known systems can be implemented only with considerable equipment-related expenditures with respect to their individual components. In addition, the known systems are distinguished by the fact that they require a relatively large amount of space which, among other things, however, is defined particularly by the above-mentioned conveying distances between the individual devices.

Furthermore, the sorting baffle has problems, in that the only small parts that can pass through take up a position in which the heads, for example, of the screws are oriented upward and the thread is oriented downward. The other small parts, which do not correspond to this position, fall back into the conveying pot. This requires a correspondingly high throughput of conveyed small parts because a considerable portion is not aligned corresponding to the defined position and has to be conveyed again.

However, the separating unit or device situated on the output side, for the purpose of operating economically, requires a continuous transfer of small parts which is not sufficiently ensured by the known systems.

### SUMMARY

The present disclosure relates to a system such that, on the whole, takes up a compact three-dimensional space and is optimized with respect to its economical operation.

Therefore, the present disclosure relates to a system for separating and aligning small parts, each small part having a head. The small parts are deposited in bulk in a storage container. The system includes a separating device arranged on an output side of the storage container. An aligning station adjoins the separating device and precisely positions each small part in a heads-up orientation to be transferred. A transfer device connected with the aligning station transfers each small part to a processing unit.

Because of the fact that, according to the present disclosure, the separating device is arranged directly behind the storage container, that is, is assigned to the latter, the small parts can be transferred in a precise position and sequence by the aligning station and the transfer device to the processing unit. That permits a continuous operation, particularly of the processing unit.

The system, according to the present disclosure can be produced in an extremely compact construction, while conveyor belts or the like are eliminated.

The separating device includes a ring which rotates in the vertical plane and whose interior surface area has pockets embedded in the radial direction. The ring can be driven by an application to it's exterior surface area. Plates, resting in areas on the two plane surfaces of the ring, form a chamber in which a small number of small parts to be separated are stored.

The separating device permits a high conveying rate. That is, essentially each pocket, after a passage through the chamber, is occupied by a small part and can be transferred to the aligning station in this state.

As a result of the shaping of the pockets or their arrangement, the small parts are held in the respective pocket over a relatively large conveying angle range and are released only directly before reaching the highest rotating position, as a result of, as it were, a dumping.

The aligning station is therefore also arranged in this area, so that only a low height of fall of the small part has to be overcome, whereby a very secure transfer into the aligning station can take place.

The conveying of the small parts by the ring preferably takes place in a timed manner, the triggering of the timing taking place by a sensor, which determines whether each pocket rotating past is occupied by a small part.

As a result of the timed movement, only one small part arrives in the aligning station and, in the further course, in the processing unit.

For controlling the entire system, a demand monitoring device can be provided which is coupled with the processing unit and by which the operation of the separating device is interrupted in the event that no additional small part is needed for further processing.

For this event, another sensor is provided in the aligning unit which determines whether a small part is still present in the output of the aligning station.

The aligning station may be designed such that two cheeks are provided which jointly bound a longitudinal slot whose width corresponds approximately to the diameter of the shank of the respective small part but is, in each case, smaller than the diameter of the head. The longitudinal slot extends as an inclined plane, specifically, sloped starting from the separating device to the transfer device, in which case the edge areas laterally bounding the longitudinal slot, which also extend in a correspondingly sloped manner, each form the support for the head of the small part. The slope of the inclined plane is selected such that the small part can slide downward without any problem, taking up a position perpendicular to the axial direction, which position necessarily occurs as a result of the inclined plane.

Other aspects of the present disclosure will become apparent from the following descriptions when considered in conjunction with the accompanying drawings.

### BRIEF DESCRIPTION OF THE DRAWINGS

FIG. 1 is a perspective view of a system, according to the present disclosure.

FIG. 2 is a perspective view of a portion of the system of FIG. 1.

FIG. 3 is a perspective cut-a-way view of an embodiment of an aligning station, according to the present disclosure.

FIG. 4 is a sectional lateral view of another embodiment of an aligning station, according to the present disclosure.

FIG. 5 is a frontal sectional view of the aligning station of FIG. 4.

### DETAILED DESCRIPTION OF THE DRAWINGS

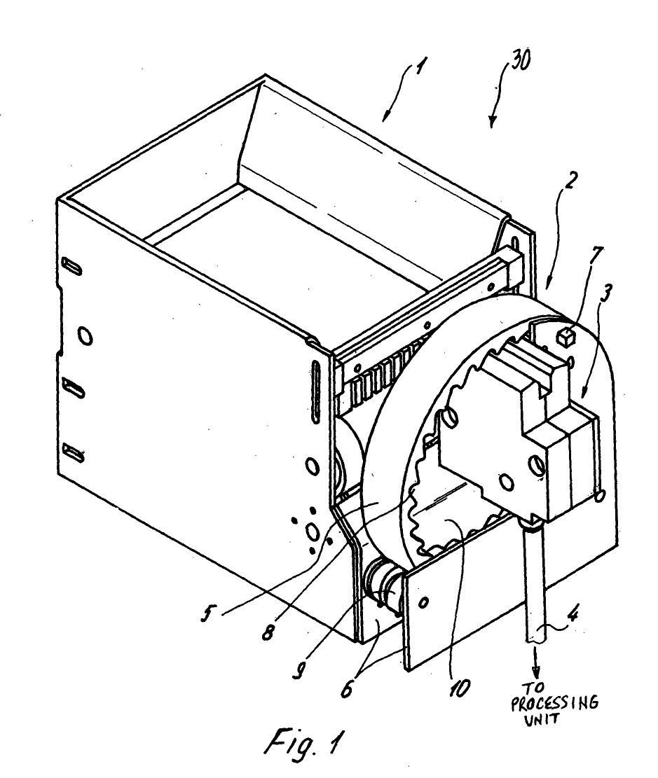

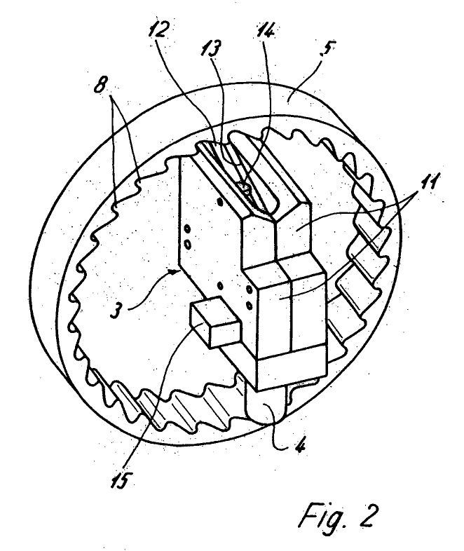

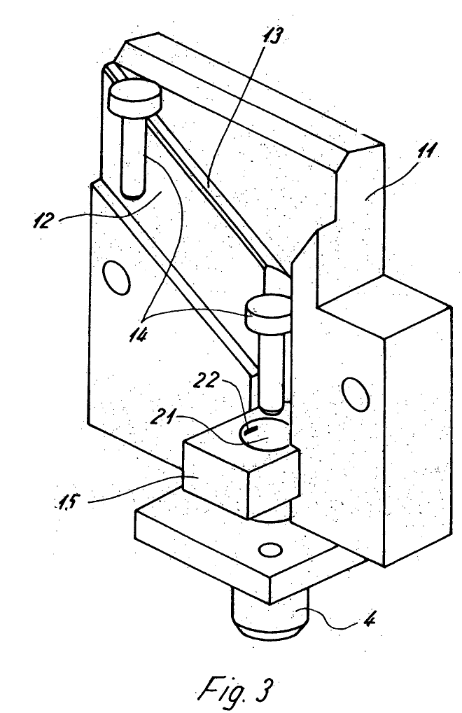

FIG. 1 illustrates a system 30 for separating and aligning small parts 14, as shown in FIGS. 2-5, which small parts 14 are each provided with a head. For example, the small parts 14 may be screws which are deposited as bulk material in a storage container 1 (see FIG. 1). Alternatively, the small parts 14 may be rivets, as shown in FIG. 3, or they may be equivalent connection elements.

A separating device 2 is assigned to the storage container 1 and is adjoined by an aligning station 3 connected with a transfer device 4. Through the aligning station 3, each small part 14 can be positioned in a precise position and transferred in this state to a processing unit which is not shown.

The separating device 2 includes a separating wheel, constructed as a ring 5, whose interior surface area has pockets 8 which are embedded in a radial direction and are uniformly distributed along a circumference of the ring 5.

An exterior surface area of the ring 5 is disposed on driving rollers 9 by which the ring 5 can be rotated around a horizontal axis in a vertical direction.

Two plates 6 rest against two faces or planar surfaces of the ring 5 and, together with an interior surface area of the ring 5, form a chamber 10 in which a certain number of small parts 14 are disposed, and which small parts 14 have been transported out of the storage container 1 in a separate manner.

In an upper interior area of the ring 5, the aligning station 3 is arranged at a small distance from the pockets 8.

The aligning station 3 includes two cheeks 11, which rest on one another and which jointly laterally bound a longitudinal slot 12. The longitudinal slot 12 includes supports or lateral edge areas 13, as shown in the embodiment according to FIGS. 2 and 3. The lateral edges 13 may be constructed as an inclined plane and, starting from the ring 5, extends in a sloped manner toward an outside of the aligning station 3.

As a result of the force of gravity, a small part 14 is conveyed into an area above the aligning station 3 and is disposed in a pocket 8, falling with its shank into the longitudinal slot 12, while its head is supported on the edge areas 13. In this case, a width of the longitudinal slot 12 corresponds approximately to a diameter of the shank of the small part 14, but is at least smaller than a diameter of the head of the small part 14.

For a continuous feeding of the small parts 14 to the processing unit (not shown), a rotation of the ring 5 in a timed manner may take place, specifically as a function of whether or not a small part 14 is transported in a pocket 8. For this purpose, a first sensor 7 may be provided on an exterior side, preferably connected to at least one of the plates 6, which first sensor 7 indicates whether a small part 14 occupies a pocket 8. The timed manner may be controlled by a second sensor 22, as shown in FIG. 3.

As a result of the timed movement, only one small part 14 may be located in the aligning station 3, which small part 14 is fed by compressed air via the transfer device 4 to the processing unit (not shown).

As illustrated in FIGS. 2 and 3, the aligning station may include a monitoring device 15 having a through-hole or opening 21. The lateral edge areas 13 guide the small parts 14 into the opening 21 from where the small parts 14 are transported to the transfer device 4 and on to the processing unit. The second sensor 22 may be located in a wall of the opening 21, as shown in FIG. 3. The second sensor 22 may detect a small part 14 falling through the opening 21. A signal from the second sensor 22 leads to a rotation of the ring 5 until another small part 14 falls out of one of the pockets 8 and into the aligning station 3.

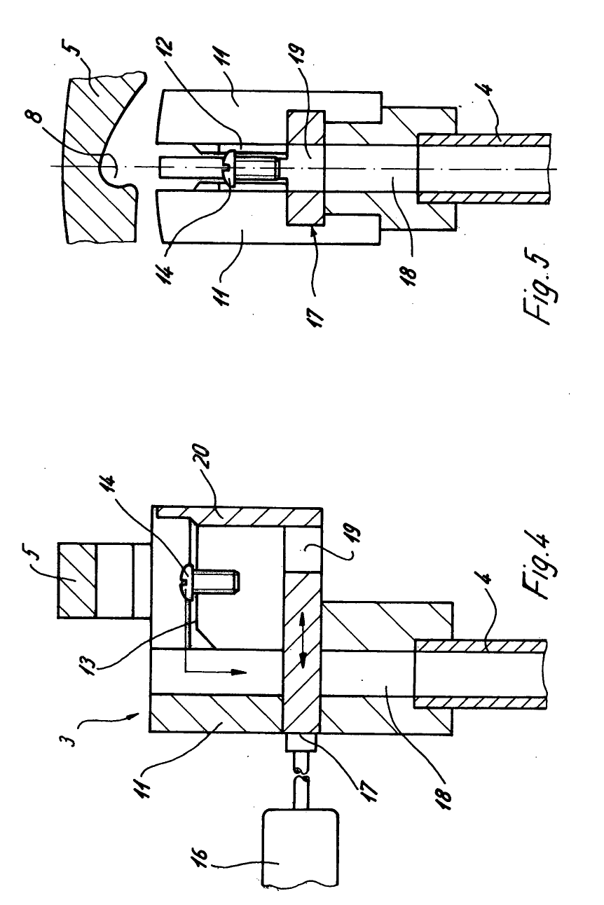

FIGS. 4 and 5 show another embodiment of an aligning station 3, in which a transport of an aligned small part 14 takes place by a driving device 20 into feeding station or transfer device 4.

This driving device 20 is a component of a slide 17 connected to a pneumatically or similarly operable cylinder 16 and guides the small part 14, resting with its head on the supports or lateral edges 13, into a feeding shaft 18 which leads into the transfer device 4.

In order to provide a free passage through the feeding shaft 18, the slide 17 has a passage 19 on its side adjacent to the driving device 20, which passage 19 is congruently situated in a transfer position of the small part 14 in the feeding shaft 18. During its driving movement, the driving device 20 moves through the longitudinal slot 12, for the purpose of which its width is slightly smaller than the width of the longitudinal slot 12.

Although the present disclosure has been described and illustrated in detail, it is to be clearly understood that this is done by way of illustration and example only and is not to be taken by way of limitation. The spirit and scope of the present disclosure are to be limited only by the terms of the appended claims.

I claim:

1. A system for separating and aligning small parts, each small part having a head and the small parts being deposited in bulk in a storage container, the system comprising:
a separating device arranged on an output side of the storage container;
an aligning station adjoining the separating device, the aligning station precisely positioning each small part in a heads up orientation to be transferred; and
a transfer device, connected with the aligning station, transferring each small part to a processing unit.

2. The system according to claim 1, wherein the separating device includes a ring whose interior surface area has pockets embedded in a radial direction, and which ring can be rotated by a drive applied to an exterior surface area of the ring, the ring rotating about a horizontal axis.

3. The system according to claim 2, wherein two plates, forming a chamber, rest on two surfaces of the ring.

4. The system according to claim 2, wherein the ring can be rotated in a timed manner.

5. The system according to claim 3, wherein the aligning station is arranged directly below one of the pockets, which pocket is in a respective timed position, and the chamber is positioned below the aligning station.

6. The system according to claim 2, wherein a first sensor, which is stationary with respect to the rotatable ring, is provided, the first sensor indicating whether a small part occupies one of the pockets.

7. The system according to claim 4, wherein the timed manner can be controlled by a second sensor.

8. The system according to claim 2, wherein the ring can be driven by way of driving rollers resting against an exterior surface area of the ring.

9. The system according to claim 1, wherein the aligning station includes two cheeks between which a longitudinal slot is formed whose upper lateral edge areas each form a support for a head of the small part, and a width of the slot being larger than a shaft diameter of the small part but smaller than the head's diameter of the small part.

10. The system according to claim 9, wherein the supports are constructed as an inclined plane which slopes from the ring toward an outside area of the aligning station.

11. The system according to claim 9, wherein the aligning station includes a pneumatically operated driving device by which a small part, resting on the supports, can be pushed into a feeding shaft which leads into the transfer device.
